(19) United States
(12) Patent Application Publication
(10) Pub. No.: US 2009/0111519 A1
(43) Pub. Date: Apr. 30, 2009

(54) FM CHANNEL SCANNING

(75) Inventor: Asif Grushkevich, La Jolla, CA (US)

Correspondence Address: BRAKE HUGHES BELLERMANN LLP;c/o CPA Global, P.O. Box 52050, Minneapolis, MN, 55402, US

(73) Assignee: BROADCOM CORPORATION, Irvine, CA (US)

(21) Appl. No.: 11/933,206

(22) Filed: Oct. 31, 2007

(51) Int. Cl. H04B 1/38; G10L 11/00; H04B 7/00; H04B 1/18

(52) U.S. Cl. 455/557; 455/150.1; 455/41.2; 455/90.1; 704/200

(57) ABSTRACT

A system may include a buffer that is arranged and configured to receive an audio input signal and to buffer the audio input signal for a period of delay time, where the audio input signal includes one or more periods of silence and one or more periods of content and a processor that is arranged and configured to search the audio input signal for the periods of silence during the period of delay time. The system also may include a frequency modulation (FM) receiver that is arranged and configured to be enabled by the processor during the periods of silence to scan an FM spectrum for available frequencies for transmission and an FM transmitter that is arranged and configured to transmit the audio input signal on an FM frequency and to be disabled by the processor during the periods of silence.

### TECHNICAL FIELD

This description relates to frequency modulation (FM) channel scanning.

### BACKGROUND

The FM spectrum includes frequencies over which an audio signal may be transmitted. A device such as an MP3 player, for example, may include an FM transmitter such that the audio content of the MP3 player may be transmitted to another device, such as a car radio. The quality of this transmission may be affected by other FM radio stations broadcasting on the same or nearby frequency that the FM transmitter is using to transmit the audio content of the MP3 player.

### SUMMARY

The details of one or more implementations are set forth in the accompanying drawings and the description below. Other features will be apparent from the description and drawings, and from the claims.

### BRIEF DESCRIPTION OF THE DRAWINGS

FIG. 1 is an exemplary block diagram of a system for FM channel scanning.

FIG. 2 is an exemplary block diagram of an exemplary implementation of the system of FIG. 1.

FIG. 3 is an exemplary graph of an audio input signal.

FIG. 4 is an exemplary flowchart illustrating example operations of the system of FIG. 1.

### DETAILED DESCRIPTION

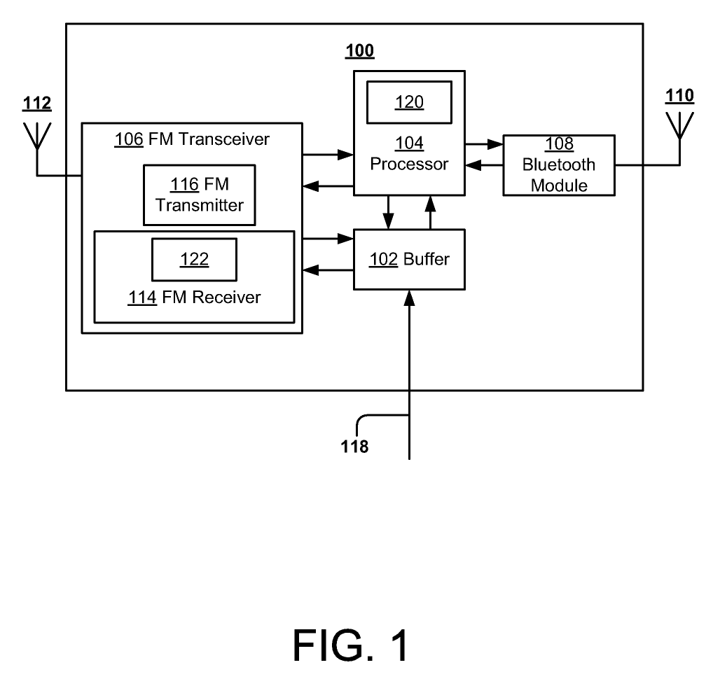

Referring to FIG. 1, a system 100 for FM channel scanning may include a buffer 102, a processor 104, and an FM transceiver 106. System 100 also may include a Bluetooth® module 108 that is connected to an antenna 110. The FM transceiver 106 may be connected to an antenna 112 and may include an FM receiver 114 and an FM transmitter 116.

In one general aspect, system 100 may receive an audio input signal 118. The buffer 102 may be arranged and configured to receive the audio input signal 118 and to buffer the audio input signal 118 for a period of time delay. The audio input signal 118 may include one or more periods of silence and one or more periods of content. The processor 104 may be arranged and configured to search the audio input signal 118 for the periods of silence during the period of delay time. The FM receiver 114 may be arranged and configured to be enabled by the processor 104 during the periods of silence to scan an FM spectrum for available frequencies for transmission. The FM transmitter 116 may be arranged and configured to transmit the audio input signal 118 on an FM frequency and to be disabled by the processor 104 during the periods of silence. In this manner, the FM receiver 114 is essentially performing a scan for available frequencies in the background during the transmission of the audio input signal 118. The FM transmitter 116 may be enabled by the processor 104 during the periods of content and may be disabled during the periods of silence, so that the FM receiver may scan for clear frequencies on the FM spectrum during the periods of silence.

In one exemplary implementation, the system 100 may be arranged and configured to operate in many different types of devices. For example, system 100 may be arranged and configured to operate in a cellular phone, a smart phone, an MP3 player, an iPod® player, a personal digital assistant (PDA), a mobile handset, other types of devices, and/or in devices that include a combination of these types of devices.

The system 100 may be arranged and configured to receive an audio input signal 118 and to transmit the audio input signal 118 to another device, such as another device that includes an FM receiver. For instance, the system 100 may receive the audio input signal 118 and transmit the audio input signal to a car radio's FM receiver so that the audio input signal can be heard using the car's speakers.

In one exemplary implementation, the system 100 may be arranged and configured to be implemented as an integrated circuit. The integrated circuit may be arranged and configured to operate in a cellular phone, a smart phone, an MP3 player, an iPod® player, a personal digital assistant (PDA), a mobile handset, other types of devices, and/or devices that include any combination of these types of devices. The integrated circuit may be arranged and configured to be implemented as a single chip solution that operates in the different types of applications described above.

The buffer 102 may be arranged and configured to receive the audio input signal 118. The buffer 102 may buffer the audio input signal for a period of delay time. The audio input signal 118 may be a continuous stream of audio input, such that as the continuous audio stream enters the buffer, it is delayed for the period of delay time. The period of delay time may not be noticeable to a user who is expecting the audio input signal to be transmitted to another device by the FM transmitter 116. In one exemplary implementation, the period of delay time may be for a short period of delay time on the magnitude of milliseconds and/or microseconds.

The buffer 102 may be used to enable the processor 104 the period of delay time to analyze the audio input signal 118. The processor 104 may be arranged and configured to search the audio input signal 118 for the periods of silence. The processor 104 may perform this search during the period of delay time before the FM transmitter 116 begins transmitting the audio input signal 118. The processor 104 may be a microprocessor that also is arranged and configured to perform other functions.

The processor 104 may include a memory module 120 that may store information obtained by the processor 104 from the search for the periods of silence. The information related to the periods of silence may be used by the processor 104 to control the FM transceiver 106. For instance, the information may be used by the processor 104 to control the enabling and disabling of the FM transmitter 116 and the FM receiver 114. The processor 104 may control the FM transmitter 116 and the FM receiver 114 such that the FM transmitter 116 may be enabled when the FM receiver 114 is disabled. Similarly, the processor 104 may control the FM transmitter 116 and the FM receiver 114 such that the FM transmitter 116 may be disabled when the FM receiver 114 is enabled. The processor 104 may control the FM transmitter 116 and the FM receiver 114 such that both devices are not enabled at the same time.

In other exemplary implementations, the processor 104 may be arranged and configured to search the audio input signal 118 for the periods of content. The processor 104 may perform this search during the period of delay time before the FM transmitter 116 begins transmitting the audio input signal 118. The memory module 120 may be configured to store information obtained by the processor 104 from the search for the periods of content. The information related to the periods of content may be used by the processor 104 to control the FM transceiver 106. For instance, the information may be used by the processor 104 to control the enabling and disabling of the FM transmitter 116 and the FM receiver 114. The processor 104 may control the FM transmitter 116 and the FM receiver 114 such that the FM transmitter 116 may be enabled when the FM receiver 114 is disabled. Similarly, the processor 104 may control the FM transmitter 116 and the FM receiver 114 such that the FM transmitter 116 may be disabled when the FM receiver 114 is enabled. The processor 104 may control the FM transmitter 116 and the FM receiver 114 such that both devices are not enabled at the same time.

After the processor 104 determines the information that it needs to control the FM transceiver 106, then the audio input signal 118 is sent to the FM transceiver 106. The FM transceiver 106 includes an FM receiver 114 and an FM transmitter 116. The FM receiver 114 may be arranged and configured to be enabled by the processor 104 during the periods of silence to scan the FM spectrum for available frequencies for transmission. The FM receiver 114 may scan the FM spectrum by automatically going through each potential frequency and determining whether a signal is present on that particular frequency by measuring a signal strength (e.g., received signal strength indication (RSSI)). A signal may be considered present on a particular frequency if the signal strength (e.g., RSSI) on the specific frequency meets and/or exceeds a signal strength threshold. A particular frequency may be considered available and clear if the signal strength (e.g., RSSI) is equal to and/or below a signal strength threshold. If the FM receiver 114 finds an available frequency, then the information about the available frequency may be saved in memory 120 such that processor 104 can switch the FM transmitter 116 to the available frequency at a desired time.

While the FM receiver 114 is enabled during the periods of silence, the FM transmitter 116 may be disable by the processor 104. The FM transmitter 116 may be disabled during this period without affecting the audio experience of a user, because it is during periods of silence that the FM transmitter 116 is being disabled. Even if the FM transmitter 116 had been enabled during those periods of silence, the user would not have perceived any sound.

The FM receiver 114 may be arranged and configured to be disabled by the processor 104 during the periods of content and the FM transmitter 116 may be enabled by the processor 104 during the periods of content. The FM transmitter 116 may be arranged and configured to transmit the audio input signal 118 using antenna 112. The FM transmitter 116 may be enabled to transmit the periods of content and may be disabled during the period of silence. By disabling the FM transmitter 116 during the periods of silence, the FM receiver is able to scan the FM spectrum for available frequencies. This enabling and disabling of the FM transmitter 116 and the FM receiver 114 is transparent to a user such that the result perceived by the user is an uninterrupted transmission of the audio input signal. Thus, the effect of system 100 is a background scanning for available frequencies during the transmission of the audio input signal to the user.

In one exemplary implementation, the FM receiver 114 may include a radio data system (RDS)/radio broadcast data system (RBDS) receiver 122. The RDS/RBDS receiver 122 may be arranged and configured to receive RDS/RBDS data.

In one exemplary implementation, the system 100 may include a Bluetooth module 108 and an antenna 110. The Bluetooth module 108 may be arranged and configured to include a Bluetooth transceiver that enables information to be communicated using the Bluetooth protocol between system 100 and other Bluetooth-compatible devices.

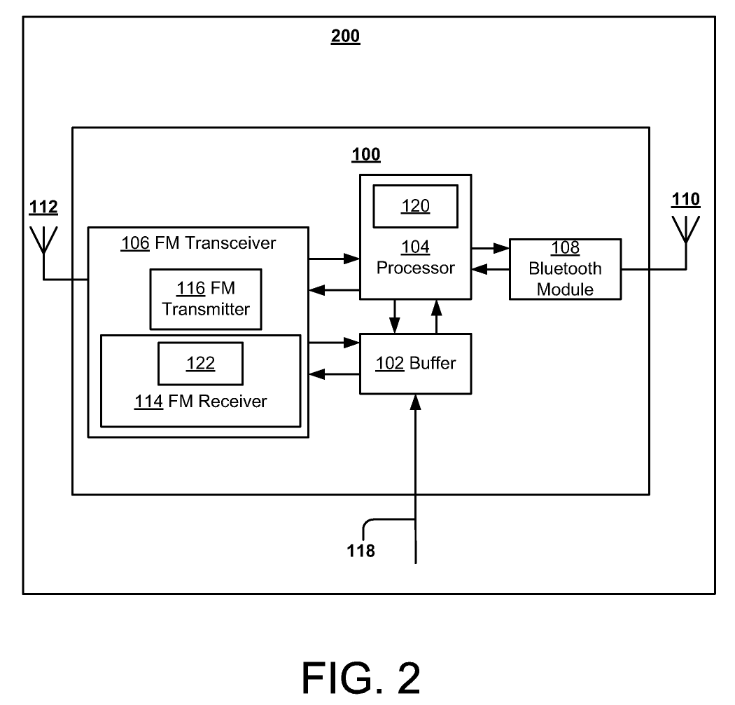

Referring also to FIG. 2, system 100 may be integrated or otherwise be made a part of a device 200. For example, device 200 may include, for example, a cellular phone, a smart phone, an MP3 player, an iPod® player, a personal digital assistant (PDA), a mobile handset, other types of devices, and/or devices that include any combination of these types of devices. The audio input signal 118 may be any type of audio signal. In one exemplary implementation, the audio input signal 118 may originate from within device 200 and be input into system 100. System 100 may then broadcast the audio input signal 118 over an available frequency using the FM transmitter 116.

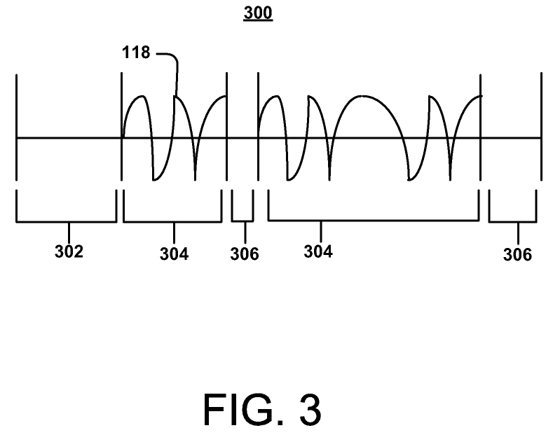

Referring to FIG. 3, a exemplary graph 300 of the audio input signal 118 is illustrated. In exemplary graph 300, the audio input signal 118 may be buffered by the buffer 102 of FIGS. 1 and 2 for a period of delay time 302. The audio input signal 118 may include one or more periods of content 304 and one or more periods of silence 306. The one or more periods of silence may occur, for example, between words, between songs, between tracks of an audio signal playing music, and at other places.

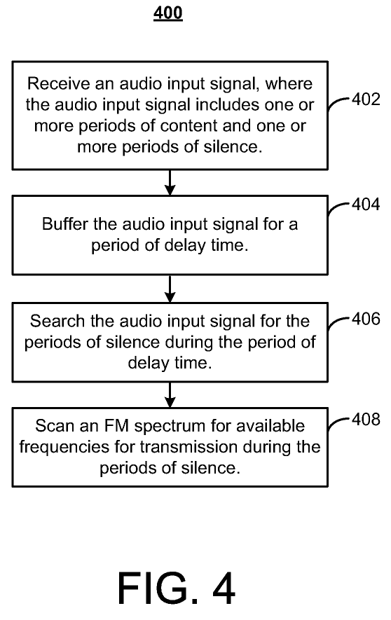

Referring to FIG. 4, an exemplary process 400 for FM channel scanning is illustrated. Process 400 may include receiving an audio input signal, where the audio input signal includes one or more periods of content and one or more periods of silence (402). Process 400 also may include buffering the audio input signal for a period of delay time (404), searching the audio input signal for the periods of silence during the period of delay time (406) and scanning an FM spectrum for available frequencies for transmission during the periods of silence (408). Process 400 may further include transmitting the audio input signal.

In one exemplary implementation, process 400 may be implemented by system 100 of FIGS. 1 and 2, as described above. For example, system 100 may receive an audio input signal 118 (402). The audio input signal 118 may be received by buffer 102 (402) and buffer 102 may buffer the audio input signal 118 for a period of delay time (404). The processor 104 may be arranged and configured to search the audio input signal 118 for the periods of silence during the period of delay time (406). The FM receiver 114 may be arranged and configured to scan the FM spectrum for available frequencies for transmission during the periods of silence (408). The FM transmitter 116 may be arranged and configured to transmit the audio input signal.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A system comprising:
a buffer that is arranged and configured to receive an audio input signal and to buffer the audio input signal for a period of delay time, wherein the audio input signal includes one or more periods of silence and one or more periods of content;
a processor that is arranged and configured to search the audio input signal for the periods of silence during the period of delay time;
a frequency modulation (FM) receiver that is arranged and configured to be enabled by the processor during the periods of silence to scan an FM spectrum for available frequencies for transmission; and
an FM transmitter that is arranged and configured to transmit the audio input signal on an FM frequency and to be disabled by the processor during the periods of silence.

2. The system of claim 1 wherein the FM transmitter is arranged and configured to transmit the audio signal during the periods of content.

3. The system of claim 1 wherein the FM receiver is arranged and configured to be disabled by the processor when the FM transmitter is enabled by the processor.

4. The system of claim 1 wherein the periods of silence occur between words in the audio input signal.

5. The system of claim 1 wherein the periods of silence occur between songs in the audio input signal.

6. The system of claim 1 further comprising a Bluetooth transceiver.

7. The system of claim 1 wherein the system is arranged and configured to operate in a cellular phone.

8. The system of claim 1 wherein the system is arranged and configured to operate in an MP3 player.

9. The system of claim 1 wherein the system is arranged and configured to operate in a personal digital assistant (PDA) device.

10. An integrated circuit comprising:
a buffer that is arranged and configured to receive an audio input signal and to buffer the audio input signal for a period of delay time, wherein the audio input signal includes one or more periods of content and one or more periods of silence;
a processor that is arranged and configured to search the audio input signal for the periods of silence during the period of delay time;
a frequency modulation (FM) receiver that is arranged and configured to be enabled by the processor during the periods of silence to scan an FM spectrum for available frequencies for transmission; and
an FM transmitter that is arranged and configured to transmit the audio input signal on an FM frequency and to be disabled by the processor during the periods of silence.

11. The integrated circuit of claim 10 wherein the FM transmitter is arranged and configured to transmit the audio signal during the periods of content.

12. The integrated circuit of claim 10 wherein the FM transmitter is arranged and configured to transmit the audio signal during the periods of content.

13. The integrated circuit of claim 10 wherein the periods of silence occur between words in the audio input signal.

14. The integrated circuit of claim 10 wherein the periods of silence occur between songs in the audio input signal.

15. The integrated circuit of claim 10 further comprising a Bluetooth transceiver.

16. The integrated circuit of claim 10 wherein the integrated circuit is arranged and configured to operate in a cellular phone.

17. The integrated circuit of claim 10 wherein the integrated circuit is arranged and configured to operate in an MP3 player.

18. The integrated circuit of claim 10 wherein the integrated circuit is arranged and configured to operate in a personal digital assistant (PDA) device.

19. A method for FM channel scanning, the method comprising:
receiving an audio input signal, wherein the audio input signal includes one or more periods of content and one or more periods of silence;
buffering the audio input signal for a period of delay time;
searching the audio input signal for the periods of silence during the period of delay time; and
scanning an FM spectrum for available frequencies for transmission during the periods of silence.

20. The method as in claim 19 further comprising transmitting the audio input signal on one of the available frequencies.
